(19) United States
(12) Patent Application Publication
(10) Pub. No.: US 2025/0248450 A1
(43) Pub. Date: Aug. 7, 2025

(54) HEATER ASSEMBLY WITH EXTERNAL MICROPOROUS INSULATION

(71) Applicant: Philip Morris Products S.A., Neuchatel (CH)

(72) Inventors: Michel BESSANT, Neuchatel (CH); Hrayr HOVSEPYAN, Yerevan (AM)

(73) Assignee: Philip Morris Products S.A., Neuchatel (CH)

(21) Appl. No.: 18/854,857

(22) PCT Filed: May 4, 2023
(86) PCT No.: PCT/EP2023/061798

§ 371 Date: Oct. 7, 2024

(30) Foreign Application Priority Data
May 4, 2022 (AM) AM20220047

(51) Int. Cl. A24F 40/465

(52) U.S. Cl. CPC A24F 40/465

(57) ABSTRACT

A heater assembly for an aerosol-generating device is provided, the heater assembly including: a heating chamber configured to heat an aerosol-forming substrate, the heating chamber being defined by heating chamber walls; and a heater casing arranged externally to the heating chamber, the heater casing being defined by heater casing walls; and a microporous insulating material arranged externally to the heater casing, the microporous insulating material being formed from at least a first insulating element including at least one first connection element and a second insulating element including at least one second connection element, and the first connection element and the second connection element being configured as matching connection elements.

The present disclosure relates to a heater assembly for an aerosol-generating device. The present disclosure further relates to an aerosol-generating device. The present disclosure further relates to an aerosol-generating system comprising an aerosol-generating device and an aerosol-forming substrate.

It is known to provide an aerosol-generating device for generating an inhalable vapor. Such devices may heat an aerosol-forming substrate contained in an aerosol-generating article without burning the aerosol-forming substrate. The aerosol-generating article may have a rod shape for insertion of the aerosol-generating article into a heating chamber of the aerosol-generating device. A heating element is typically arranged in or around the heating chamber for heating the aerosol-forming substrate once the aerosol-generating article is inserted into the heating chamber of the aerosol-generating device.

Heat produced by the heating element may inadvertently be dissipated away from the heating chamber. Heat may be dissipated to the environment or to other components of the aerosol-generating system. Heat may inadvertently be dissipated away from the heating chamber via free air convection. Heat may inadvertently be dissipated away from the heating chamber via radiation. Heat may inadvertently be dissipated away from the heating chamber by heat conduction via components of the aerosol-generating device. Heat may inadvertently be dissipated away from the heating chamber by heat conduction via components of the aerosol-generating article, for example via the aerosol-forming substrate. Heat dissipation away from the heating chamber may cause heating of components of the device that are not intended to be heated. For example, a housing of the device to be grasped by a user may become uncomfortably hot. Heat dissipation away from the heating chamber may cause heat losses within the heating chamber. Heat losses within the heating chamber may result in a less efficient heating. An excess amount of energy may be required to heat the heating chamber to a desired temperature.

It would be desirable to have an aerosol-generating device that may reduce heat losses from the heating chamber. It would be desirable to thermally insulate the heating chamber with respect to other components of the aerosol-generating device. It would be desirable to have an aerosol-generating device that may reduce heating up of the outer housing of the device to be grasped by a user. It would be desirable to have an aerosol-generating device that may provide effective thermal insulation. It would be desirable to have an aerosol-generating device that may provide thermal insulation at low manufacturing costs. It would be desirable to have an aerosol-generating device that may provide lightweight thermal insulation. It would be desirable to have an aerosol-generating device that may have an improved thermal insulation. It would be desirable to have an aerosol-generating device that may have a reduced external diameter of the heater casing. It would be desirable to have an aerosol-generating device that may have more compact device dimensions.

According to an embodiment of the invention there is provided a heater assembly for an aerosol-generating device. The heater assembly comprises a heating chamber for heating an aerosol-forming substrate. The heating chamber may be defined by heating chamber walls. The heater assembly may further comprise a heater casing arranged externally to the heating chamber. The heater casing may be defined by heater casing walls. The heater assembly further comprises a microporous insulating material arranged externally to the heater casing.

Thus, there may be provided a heater assembly for an aerosol-generating device, the heater assembly comprising a heating chamber for heating an aerosol-forming substrate, the heating chamber being defined by heating chamber walls, and a heater casing arranged externally to the heating chamber, the heater casing being defined by heater casing walls, in which the heater assembly further comprises a microporous insulating material arranged externally to the heater casing.

Heater casings of aerosol-generating devices may be insulated by insulating materials, such as polymers. If so, appropriate materials need to be selected, materials that will not degrade due to heat caused by operation of the device. Insulation may be provided by a gap between the heater casing and any outer housing, thereby using air as an insulating material. However, with higher temperatures the thermal conductivity of air increases, and an air gap alone may need to be wide to perform a desired insulation role. Microporous insulating materials comprise small cavities or pores. Within these cavities air or other gaseous compositions are encapsulated. Microporous insulating materials may thus have improved thermal barrier properties with rising temperatures compared to both solid materials and air. Microporous insulating materials may retain, or almost retain, a thermal conductivity at the operating temperature of an aerosol-generating device as well as low thermal conductivity at room temperature. The low thermal conductivity of a microporous insulating material at operating temperature of an aerosol-generating device results in a better thermal insulation. Due to the better thermal insulation, a heater assembly comprising the microporous insulating material may have a reduced external diameter.

The heater assembly may be configured such that the heater casing is arranged externally to outer surfaces of the heating chamber walls. For example, the heater casing may be arranged around the heating chamber, or may substantially surround the heating chamber. In this way, the heater casing itself acts, to some extent, as a thermal barrier. Moving air, which may otherwise be present around the external surface of the heater casing may have a thermal conductivity ranging from 0.5 W/m·K to at least 25 W/m·K. A microporous insulating material, such as a silica aerogel, may have a thermal conductivity of lower than 0.017 W/m·K. Not only does a microporous insulating material provide a significant improvement in thermal insulation, infrared thermal transfer may also be reduced. For example, use of a microporous thermal insulation material external to the heater casing may reduce heat losses due to infrared by an additional 10% at the operating temperature of a typical aerosol-generating device, for example operating temperatures within the range of 150 degrees Centigrade to 350 degrees Centigrade.

By locating the microporous insulating material external to the heater casing, the material is not located within the main airflow of the aerosol-generating device. Thus, any risk of contaminating the main airflow with material from the insulation is reduced. Further, the location of the microporous insulation external to the heater casing means that the maximum temperature experienced by the microporous insulating material is lower than would be the case if it were positioned within the heater casing. This not only widens the possible materials that could be used, but also helps maintain stability of the insulating material over time. The microporous insulating material should be preferably at least 0.1 mm in thickness. Benefits of a heater assembly comprising a layer of microporous insulating material located external to a heater casing may include the ability to produce an aerosol-generating device with reduced dimensions, because a thinner layer of insulating material is required, the ability to produce an aerosol-generating device with a lower external operating temperature, and the ability to save energy by reducing the heat lost to the outside world during operation of the device.

The heating chamber may have an elongate shape, for example an elongate shape defined by elongate heating chamber walls, preferably, wherein the heating chamber walls are in the form of a hollow tube. The heating chamber may be an elongate heating chamber having a substantially polygonal transverse cross-section, for example a transverse cross-section that is a substantially polygonal shape selected from the list consisting of circle, ellipse, decagon, nonagon, octagon, heptagon, hexagon, pentagon, square, rectangle, and triangle. The heating chamber may be a longitudinally extending heating chamber, preferably a longitudinally extending heating chamber defined by a base, side walls extending from the base, and an opening at an opposite end of the heating chamber to the base.

Preferably, the heating chamber is arranged to receive an aerosol-generating article comprising the aerosol-forming substrate. Such an aerosol-generating article may be in the form of a rod.

The heating chamber may be configured for at least partly receiving an aerosol-forming substrate. The heating chamber may comprise a cavity into which the aerosol-forming substrate may be inserted. The aerosol-forming substrate may be part of an aerosol-generating article. The cavity may have a shape corresponding to the shape of the aerosol-generating article to be received in the cavity. The cavity may have a circular cross-section.

The cavity may have an elliptical or rectangular cross-section. The cavity may have an inner diameter corresponding to the outer diameter of the aerosol-generating article. The heating chamber may comprise an opening at a proximal end of the heating chamber for receiving the aerosol-forming substrate. The opening may also serve as an air outlet. The heating chamber may comprise an air inlet at a distal end of the heating chamber. The heating chamber may have an elongate shape. The heating chamber may be a hollow tube. The hollow tube may be formed from a wall of the heating chamber. The wall of the heating chamber may comprise or may be made of a metal or an alloy. The wall of the heating chamber may comprise or may be made of stainless steel. The heater casing may be arranged radially distanced from the heating chamber at a distance d. The distance d may be measured in a direction orthogonal to the longitudinal axis of the heating chamber. The heating chamber may comprise a wall of the heating chamber. The heater casing may comprise a wall of the heater casing. The distance d may be measured in a radial direction between the wall of the heating chamber and the wall of the heater casing. The distance d may be measured in a radial direction between an outer side of the wall of the heating chamber and an inner side of the wall of the heater casing. The distance d between the heating chamber and the heater casing may be between 1.5 millimeters and 7 millimeters. The distance d between the heating chamber and the heater casing may be between 2 millimeters and 4 millimeters, preferably about 3.1 millimeters. The heater casing may be coaxially aligned around the heating chamber. The heating chamber and the heater casing may have matching shapes. The matching shapes may allow to provide a constant radial distance d between the heater casing and the heating chamber. The wall of the heater casing may match the shape of the wall of the heating chamber along the longitudinal axis of the heating chamber such that the distance d may be approximately constant. For example, the heating chamber may be a hollow tube and the wall of the heater casing may be a cylindrical wall being coaxially aligned around the heating chamber. The distance d may be measured in a radial direction between the outer diameter of the hollow tube of the heating chamber and the inner diameter of the cylindrical wall of the heater casing. For example, the heating chamber may be a hollow truncated cone and the wall of the heater casing may be a coaxially aligned conical wall. The skilled person will understand that other types of matching shapes will be possible. For example, the matching shapes may be curved or wavy, or may comprise a combination of different shapes along the longitudinal axis of the heating chamber. The heating chamber and the heater casing may have deviating shapes. The shape of the wall of the heater casing may, to some extent, deviate from the shape of the wall of the heating chamber along the longitudinal axis of the heating chamber. The shape of the wall of the heater casing may deviate from the shape of the wall of the heating chamber along the longitudinal axis of the heating chamber such that the distance d does not vary by more than 1 millimeter along the longitudinal axis of the heating chamber. For example, the heating chamber may be a right circular hollow cylinder and the wall of the heater casing may be a slightly conical hollow cylinder being coaxially aligned around the heating chamber. Due to the conical shape of the wall of the heater casing, the distance d may vary along the longitudinal axis of the heating chamber by not more than 1 millimeter.

An external diameter of the heater casing may be measured in a direction orthogonal to the longitudinal axis of the heating chamber. An external diameter of the heater casing may be between 8 millimeters and 20 millimeters, preferably between 14 millimeters and 18 millimeters and preferably about 16 millimeters.

An external diameter of the heating chamber may be measured in a direction orthogonal to the longitudinal axis of the heating chamber. A ratio of an external diameter of the heater casing to an external diameter of the heating chamber may be between 1.3 and 3.5, preferably between 1.5 and 2.5, more preferably about 2.0. In particularly, in one embodiment the external diameter of the heating chamber may be about 5.6 millimeters and the external diameter of the heater casing may be about 17 millimeters, resulting in a ratio of about 3.0. In one embodiment the external diameter of the heating chamber may be about 5.6 millimeters and the external diameter of the heater casing may be about 16.5 millimeters, resulting in a ratio of about 2.95. In one embodiment the external diameter of the heating chamber may be about 7.6 millimeters and the external diameter of the heater casing may be about 16.5 millimeters, resulting in a ratio of about 2.17.

The heater casing may have an elongate shape, for example an elongate shape defined by elongate heater casing walls. The heater casing walls may be in the form of a hollow tube.

The heater casing may define an elongate cavity surrounding at least a portion of the heating chamber. Such an elongate cavity may have a substantially polygonal transverse cross-section, for example a transverse cross-section that is a substantially polygonal shape selected from the list consisting of circle, ellipse, decagon, nonagon, octagon, heptagon, hexagon, pentagon, square, rectangle, and triangle. The heater casing may be a longitudinally extending heater casing, preferably a substantially tubular heater casing. The heater casing is preferably arranged to be radially distanced from the heating chamber, for example in which an internal surface of a wall of the heater casing is spaced or radially spaced from an external surface of a wall of the heating chamber.

A heater assembly may be configured such that the microporous insulating material, or at least a portion of the microporous insulating material, is arranged in contact with an external surface of the heater casing. Alternatively, the microporous insulating material may be substantially spaced from an external surface of the heater casing. For example, the microporous insulating material may be spaced by a distance of greater than 0.01 mm, for example between about 0.1 mm and 5 mm, for example between 0.5 mm and 4.5 mm, for example between 1 mm and 4 mm, for example between 1.5 mm and 3.5 mm, for example between 2 mm and 3 mm, for example about 2.5 mm.

In some examples, the microporous insulating material substantially surrounds the heater casing. For example, the microporous insulating material may radially encircle the heater casing. The heater casing may have a substantially cylindrical outer surface and the microporous insulating material may radially encircle or surround at least a central portion of the heater casing.

The microporous insulating material may have a thickness of between 0.1 mm and 5 mm, for example for example between 0.5 mm and 4.5 mm, for example between 1 mm and 4 mm, for example between 1.5 mm and 3.5 mm, for example between 2 mm and 3 mm, for example about 2.5 mm.

Preferably, the microporous insulating material has a thermal conductivity of below 0.05 W/m·K, at a temperature of 280 degrees Celsius. For example, the microporous insulating material may have a thermal conductivity of below 0.04 W/m·K, more preferably of below 0.03 W/m·K, at a temperature of 280 degrees Celsius.

The thermal conductivity of air increases with rising temperatures. The thermal conductivity of air at 25 degrees Celsius is about 0.0262 W/m·K. At an operating temperature of 280 degrees Celsius, the thermal conductivity of air is already about 0.043 W/m·K. Therefore, using only air, for example in an air gap, as an insulating material requires a relatively large thickness of the air gap to provide a sufficient thermal insulation.

Microporous insulating materials may have a lower thermal conductivity than air at room temperature. At higher temperatures, the difference between the thermal conductivities of air and microporous insulating materials may be even greater. The thermal conductivity of microporous insulating materials may not increase as rapidly as the thermal conductivity of air. Microporous insulating materials may almost keep their thermal conductivity even at elevated temperatures.

For example, the microporous insulating material may have a thermal conductivity at 20 degrees Celsius of 0.018 W/m·K. At 200 degrees Celsius, the thermal conductivity of the same microporous insulating material may be 0.022 W/m·K. At a temperature of 400 degrees Celsius, the thermal conductivity of the same microporous insulating material may increase to 0.028 W/m·K, according to ASTM C177. The thermal conductivity of this exemplary microporous insulating material is, even at higher temperatures than the maximum operating temperature of an aerosol-generating device, almost the same as that of air at room temperature. A lower thermal conductivity results in a better thermal insulation. A heater assembly comprising an insulating material with a lower thermal conductivity may have a smaller thickness of insulation while providing still a sufficient thermal insulation.

The thermal conductivity of the microporous insulating material may increase by a maximum of 40 percent at a temperature of 280 degrees Celsius compared to the thermal conductivity of the microporous insulating material at room temperature. Preferably, the thermal conductivity of the microporous insulating material may increase by a maximum of by a maximum of 30 percent, more preferably by a maximum of 20 percent, at a temperature of 280 degrees Celsius compared to the thermal conductivity of the microporous insulating material at room temperature.

The “operating temperature” depends on the type of aerosol-generating device and on the aerosol-forming substrate that is used. The operating temperature of the aerosol-generating device may, for example, lie between 150 and 300 degrees Celsius. The operating temperature of the aerosol-generating device may lie between 200 and 230 degrees Celsius. In some preferred examples, the operating temperature of the aerosol-generating device may not exceed 280 degrees Celsius.

The microporous insulating material may have a pore diameter of below 100 nanometers, preferably of below 70 nanometers, more preferably of below 50 nanometers, more preferably of below 20 nanometers, more preferably of below 2 nanometers.

The microporous insulating material may be a ceramic material, for example a silica based or alumina-based material. The microporous insulating material may be selected from the list of materials consisting of MICROSIL Microporous Insulation from ZIRCAR Ceramics, Inc., Excelfrax® from Unifrax LLC, and Microtherm 1000 grade from Promat Inc.

The microporous insulating material may be inorganic. The microporous insulating material may be a ceramic. The microporous insulating material may comprise silica (SiO2). The microporous insulating material may comprise pyrogenic silica. The microporous insulating material may comprise other components like opacifiers and fibers. The opacifier may scatter infrared radiation and thereby reduce transmission of infrared radiation.

The microporous insulating material of the disclosure may have a nominal density of below 500 kg/m³, preferably of below 400 kg/m³, more preferably of below 300 kg/m³.

The microporous insulating material of the present invention may have, at 20 degrees Celsius and according to ASTM C177, a thermal conductivity of below 0.05 W/m·K, preferably of below 0.04 W/m·K, more preferably of below 0.03 W/m·K, more preferably of below 0.02 W/m·K. The microporous insulating material may have, at a temperature of 280 degrees Celsius and according to ASTM C177, a thermal conductivity of below 0.05 W/m·K, preferably of below 0.04 W/m·K, more preferably of below 0.03 W/m·K. The thermal conductivity of the microporous insulating material may increase, at a temperature of 280 degrees Celsius compared to the thermal conductivity of the microporous insulating material at 20 degrees Celsius, by a maximum of 40 percent, preferably by a maximum of 30 percent, more preferably by a maximum of 20 percent.

The microporous insulating material may be formed from at least a first insulating element comprising at least one first connection element and a second insulating element comprising at least one second connection element, wherein the first and second connection elements are configured as matching connection elements.

The first and second connection elements may be configured as male and female connection elements, as form-fit connection elements, as snap-fit connection elements, as bayonet connection elements or mixtures thereof or other commonly used connection elements known to the skilled person. The first connection element may comprise a male connection element and the second connection element may comprise a female connection element. The first connection element and the second connection element may comprise form-fit connection elements. The first connection element and the second connection element may comprise snap-fit connection elements. The first connection element and the second connection element may comprise bayonet connection elements. The microporous insulating material may be configured as a two-part assembly. The two-part assembly may comprise the first and second insulating element. The first and second insulating elements may for example be in the form of hollow half-cylinder elements. The hollow half-cylinder elements may comprise the matching first and second connection elements. When connected, the hollow half-cylinder elements may form a single hollow tube. The inner diameter of the hollow tube may have the same size than the outer diameter of the heating chamber. Thereby, a convenient assembly may be ensured. Whereas a microporous insulating material formed as one element, having the same inner diameter than the external diameter of the heating chamber, may be more difficult to assemble around the heating chamber due to friction. A close proximity or direct contact of the microporous insulating material with the heating chamber may improve the thermal insulation of the heating chamber.

A heater assembly according to the present disclosure may further comprising a first connecting wall connecting the heating chamber and the heater casing, and a second connecting wall connecting the heating chamber and the heater casing, wherein a space is defined between the heating chamber, the heater casing, and the first and second connecting walls, for example wherein an air-tight space is defined between the heating chamber, the heater casing, and the first and second connecting walls. Such, connecting walls may be oriented perpendicular to a longitudinal axis of the heating chamber.

An air-tight space may provide additional thermal insulation. Such an air-tight space may be at ambient pressure, or at least partly filled with a gaseous composition at ambient pressure.

The microporous insulating material of a heater assembly may be described as a first portion of microporous insulating material, and the heater assembly may further comprise a second portion of microporous insulating material arranged between an internal surface of the heater casing and an external surface of the heating chamber. The second portion of microporous material may be a different microporous material to the first portion of microporous material, or the same microporous material as the first portion of microporous material. The second microporous material may be a material with properties as described above for the microporous insulating material.

The heater casing may comprise or define an air-tight space. For example, an air-tight space may be defined between an internal surface of a wall of the heater casing and an external surface of a wall of the heating chamber. Such an air-tight space may contain a second portion of microporous insulating material. Such an air-tight space may comprise at least one air gap. In some examples, the second portion of microporous insulating material may be sandwiched between two radially spaced air gaps.

Where present, the second portion of microporous insulating material may be in direct contact with the heating chamber, for example in direct contact with an outer surface of the heating chamber. The second portion of microporous insulating material may be in contact with a heating element disposed on or around an outer surface of the heating chamber. The second portion of microporous insulating material may be in direct contact with the heater casing, for example in direct contact with an inner surface of the heater casing.

Where present, the second portion of microporous insulating material may be formed from at least a first insulating element comprising at least one first connection element and a second insulating element comprising at least one second connection element, wherein the first and second connection elements are configured as matching connection elements. The first connection element may comprise a male connection element and the second connection element may comprise a female connection element. The first connection element and the second connection element may comprise any suitable connection system, for example they may comprise form-fit connection elements, or comprise snap-fit connection elements, or comprise bayonet connection elements.

In some preferred embodiments, the microporous insulating material and/or the second portion of microporous insulating material, may extend parallel to the longitudinal axis of the heating chamber. For example, the heating chamber may be tubular, and the microporous insulating material may also be tubular, or substantially tubular, or coated onto the surface of a tube that surrounds the heating chamber.

A distance between the heating chamber and the heater casing, for example a spacing between an outer surface of the heating chamber and an inner surface of the heater casing, may be between 1.5 millimeters and 7 millimeters, preferably between 2 millimeters and 4 millimeters, preferably about 3.1 millimeters.

A heater assembly as described herein may further comprise a heating element. The heating element may be arranged at least partly around the heating chamber. The microporous insulating material may have a longitudinal extension that is the same or larger than the longitudinal extension of the heating element.

The heating element may be flexible and may be wrapped around the heating chamber. The heating element may be arranged between the heating chamber and the heater casing. The heating element may comprise one or more electrically conductive tracks on an electrically insulating substrate, for example a polyimide substrate.

In some embodiments, the ratio of an external diameter of the heater casing to an external diameter of the heating chamber may be between 1.3 to 3.5, preferably between 1.5 and 2.5, more preferably about 2.0. An inner side of a wall of the heater casing may comprise a metal coating, which may facilitate reflection of heat back towards the chamber and/or may distribute heat evenly over an inner surface of the heater casing, thereby reducing effect of hotspots. A wall of the heating chamber may comprise stainless steel.

Preferably, the thickness of one or more heater casing wall is below 2 millimeters, preferably below 1.2, preferably about 0.8 millimeter. The heater casing may comprise a plastic material. For example, one or more heater casing wall may comprise a plastic material, preferably a polyaryletherketone (PAEK), a polyether ether ketone (PEEK), or a polyphenylene sulfone (PPSU), more preferably a polyphenylene sulfone (PPSU).

In one aspect, an aerosol-generating device may be provided, the aerosol-generating device comprising a heater assembly according to any embodiment described herein. The heater assembly for such a device may be of narrow dimensions and the aerosol-generating device comprising such a heater assembly may, therefore, have more compact dimensions that would otherwise be anticipated. Such an aerosol-generating device preferably comprises a housing, a power supply, control electronics, and the heater assembly.

Preferably, the aerosol-generating device comprises a power supply configured to supply power to the heating element. The power supply preferably comprises a power source. Preferably, the power source is a battery, such as a lithium-ion battery. As an alternative, the power source may be another form of charge storage device such as a capacitor. The power source may require recharging. For example, the power source may have sufficient capacity to allow for the continuous generation of aerosol for a period of around six minutes or for a period that is a multiple of six minutes. In another example, the power source may have sufficient capacity to allow for a predetermined number of puffs or discrete activations of the heater assembly. The power supply may comprise control electronics. The control electronics may comprise a microcontroller. The microcontroller is preferably a programmable microcontroller. The electric circuitry may comprise further electronic components. The electric circuitry may be configured to regulate a supply of power to the heater assembly. Power may be supplied to the heater assembly continuously following activation of the system or may be supplied intermittently, such as on a puff-by-puff basis. The power may be supplied to the heater assembly in the form of pulses of electrical current.

In an aerosol-generating device, the heater assembly may be located by, or within, a housing of the aerosol-generating device. The microporous insulating material of the heater assembly may be located between an outer surface of the heater casing and an inner surface of the housing. In some embodiments, the microporous insulating material may be spaced from the inner surface of the housing. In some embodiments the microporous insulating material may be spaced from both the inner surface of the housing and from the outer surface of the heater casing. In yet further embodiments, the microporous insulating material may substantially fill a space defined between the outer surface of the heater casing and the inner surface of the housing.

The heating chamber may be defined by substantially cylindrical heating chamber walls. For example, the heater casing may be defined by substantially cylindrical heater casing walls located radially external to the heating chamber, the microporous insulating material may be located radially external to the heater casing walls, and the housing may be located radially external to the microporous insulating material. A heater may be located on at least a portion of an external surface of the heating chamber walls. In some embodiments, a sealed air-gap may be defined between the heating chamber and the heater casing.

Preferably the aerosol-generating device comprises a heater and preferably control electronics located within the housing control operation of the heater.

In preferred examples an airflow path may be defined through the heating chamber. Preferably the airflow path does not contact the microporous insulating material.

In a further aspect, an aerosol-generating system may be provided comprising an aerosol-generating device as described herein and an aerosol-forming substrate configured to be at least partly received in the heating chamber. The aerosol-forming substrate may be a component of an aerosol-generating article, for example an elongate aerosol-generating article, the aerosol generating article comprising the aerosol-forming substrate. The aerosol-generating article may comprise a mouthpiece located upstream of the aerosol-forming substrate.

The aerosol-generating article may be rod shaped, for example a substantially cylindrical aerosol-generating article, having a diameter of between 4 mm and 8 mm, for example between 4.5 mm and 7.5 mm, for example between 5 mm and 7.2 mm. The aerosol-generating device may comprise an opening configured to allow a portion of the aerosol-generating device to be inserted into the heating chamber. For example, the heating chamber may have an internal diameter that is approximately the same as the diameter of the aerosol-generating article.

As used herein, the terms “upstream” and “downstream” are used to describe the relative positions of components, or portions of components, of the heater assembly, aerosol-generating device, or aerosol-generating article in relation to the direction in which air flows through the assembly, device, or article during use thereof.

Aerosol-generating devices according to the invention may comprise a proximal end through which, in use, an aerosol exits the device. The proximal end of the aerosol-generating device may also be referred to as the mouth end or the downstream end. The mouth end is downstream of the distal end. The distal end of the aerosol-generating device may also be referred to as the upstream end. Components, or portions of components, of the aerosol-generating device may be described as being upstream or downstream of one another based on their relative positions with respect to the airflow path of the aerosol-generating device.

Aerosol-generating articles according to the invention may comprise a proximal end through which, in use, an aerosol exits the article. The proximal end of the aerosol-generating article may also be referred to as the mouth end or the downstream end. The mouth end is downstream of the distal end. The distal end of the aerosol-generating article may also be referred to as the upstream end. Components, or portions of components, of the aerosol-generating article may be described as being upstream or downstream of one another based on their relative positions with respect to the airflow path of the aerosol-generating article.

A proximal end of the heater assembly according to the invention may be configured to be arranged within an aerosol-generating device in a direction towards the mouth end or downstream end of the device. A distal end of the heater assembly according to the invention may be configured to be arranged within an aerosol-generating device in a direction towards the distal end or upstream end of the device. A longitudinal axis of the heating chamber may extend between the proximal end of the heating chamber and the distal end of the heating chamber. A longitudinal axis of the heating chamber may extend between the proximal end of the heater assembly and the distal end of the heater assembly.

As used herein, the term “aerosol-generating article” refers to an article comprising an aerosol-forming substrate that is capable of releasing volatile compounds that can form an aerosol. An aerosol-generating article may be disposable.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or liquid or may comprise both solid and liquid components. An aerosol-forming substrate may be part of an aerosol-generating article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomizer, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

In any aspect described herein, the heating chamber may comprise a temperature sensor. The temperature sensor may be on the top of the heating chamber. The heater assembly may further comprise a heating element. The heating chamber may comprise the heating element. The heating element may be arranged at least partly around the heating chamber. The heating element may be arranged at least partly around the wall of the heating chamber. Preferably, the heating element is arranged fully coaxially surrounding the outer perimeter of the wall of the heating chamber. The heating element may be arranged along at least a part of the longitudinal axis of the heating chamber. The heating element may comprise one or more electrically conductive tracks on an electrically insulating substrate. The one or more electrically conductive tracks may be resistive heating tracks. The one or more electrically conductive tracks may be configured as a susceptor to be inductively heated. The electrically insulating substrate may be a flexible substrate.

The heating element may be flexible and may be wrapped around the heating chamber. The heating element may be arranged between the heating chamber and the heater casing. In all of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics.

As described, in any of the aspects of the disclosure, the heating element may be part of the heating chamber of the heater assembly for an aerosol-generating device. The heater assembly may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni—Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation.

An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

The heating element advantageously heats the aerosol-forming substrate by means of heat conduction. The heating element may be at least partially in contact with the substrate, or the carrier on which the substrate is deposited. Alternatively, the heat from either an internal or external heating element may be conducted to the substrate by means of a heat conductive element.

During operation, the aerosol-forming substrate may be completely contained within the aerosol-generating device. In that case, a user may puff on a mouthpiece of the aerosol-generating device. Alternatively, during operation, a smoking article containing the aerosol-forming substrate may be partially contained within the aerosol-generating device. In that case, the user may puff directly on the smoking article.

The heating element may be configured as an induction heating element. The induction heating element may comprise an induction coil and a susceptor. In general, a susceptor is a material that is capable of generating heat, when penetrated by an alternating magnetic field.

According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate. When an induction heating element is employed, the induction heating element may be configured as an internal heating element as described herein or as an external heater as described herein. If the induction heating element is configured as an internal heating element, the susceptor element is preferably configured as a pin or blade for penetrating the aerosol-generating article. If the induction heating element is configured as an external heating element, the susceptor element is preferably configured as a cylindrical susceptor at least partly surrounding the cavity or forming the sidewall of the cavity.

The heating chamber may comprise a central region comprising the heating element. The term central region refers to the longitudinal direction. The heating chamber may further comprise a proximal region and a distal region. The proximal region and the distal region may be distanced from the heating element in a longitudinal direction. During use, the proximal and distal regions may be colder than the central region of the heating chamber. The first connecting wall may contact the heating chamber in the proximal region and the second connecting wall may contact the heating chamber in the distal region. The first and second connecting walls may thus contact the heating chamber at the coldest points of the heating chamber during use. Thereby, heat losses from the heating chamber to the connecting walls and the heater casing may be additionally reduced. Thermal insulation may be additionally improved.

The wall of the heating chamber may be made of stainless steel. This may beneficially enhance the effect that, during use, the proximal region and the distal region may be colder than the central region of the heating chamber. The thickness of the wall of the heater casing may be below about 2 millimeters. The thickness of the wall of the heater casing may be below 1.2 millimeter, preferably about 0.8 millimeter. The thickness of one or both of the first and second connecting walls may be below 1.2 millimeter, preferably about 0.8 millimeter. Having such thin walls, the thermal mass of the heater casing may be minimized. This may additionally reduce heat losses from the heating chamber.

One or more of the walls of the heater casing and the first and second connecting walls may be made of a low thermal conductivity material. This may additionally reduce heat losses from the heating chamber. The wall of the heater casing may comprise or may be made of a plastic material. The first and second connecting walls may comprise or may be made of a plastic material. The plastic material may comprise one or both of a polyaryletherketone (PAEK), a polyether ether ketone (PEEK), and a polyphenylene sulfone (PPSU). Preferably, the plastic material comprises a polyphenylene sulfone (PPSU). The inner side of the wall of the heater casing may comprise a metal coating. The inner side of one or both of the first and second connecting walls may comprise a metal coating. The metal coating may reduce the emissivity of the inner side of the wall. For example, the emissivity of a PEEK wall may be reduced from about 0.95 to about 0.4. The metal coating may reflect heat radiation emitted from the heating chamber. The metal coating may provide additional heat insulation of the heating chamber with respect to the outside of the heater casing. The metal coating may be a low emissivity metal coating. The metal coating may comprise one or more of aluminium, gold, and silver.

Below, there is provided a non-exhaustive list of non-limiting examples. Any one or more of the features of these examples may be combined with any one or more features of another example, embodiment, or aspect described herein.

Example Ex1: A heater assembly for an aerosol-generating device, comprising;
a heating chamber for heating an aerosol-forming substrate, the heating chamber defined by heating chamber walls; and
a heater casing arranged externally to the heating chamber, the heater casing being defined by heater casing walls;
in which the heater assembly further comprises a microporous insulating material arranged externally to the heater casing.
   Example Ex2: A heater assembly according to Ex1 in which the heater casing is arranged externally to outer surfaces of the heating chamber walls.
   Example Ex3: A heater assembly according to any preceding example in which the heater casing is arranged around the heating chamber, for example in which the heater casing substantially surrounds the heating chamber.
   Example Ex4: A heater assembly according to any preceding example, wherein the heating chamber has an elongate shape, for example an elongate shape defined by elongate heating chamber walls, preferably, wherein the heating chamber walls are in the form of a hollow tube.
   Example Ex5: A heater assembly according to any preceding example in which the heating chamber is an elongate heating chamber having a substantially polygonal transverse cross-section, for example a transverse cross-section that is a substantially polygonal shape selected from the list consisting of circle, ellipse, decagon, nonagon, octagon, heptagon, hexagon, pentagon, square, rectangle, and triangle.
   Example Ex6: A heater assembly according to any preceding example in which the heating chamber is arranged to receive an aerosol-generating article comprising the aerosol-forming substrate.
   Example Ex7: A heater assembly according to any preceding example in which the heating chamber is a longitudinally extending heating chamber, preferably a longitudinally extending heating chamber defined by a base, side walls extending from the base, and an opening at an opposite end of the heating chamber to the base.
   Example Ex8: A heater assembly according to any preceding example, wherein the heater casing has an elongate shape, for example an elongate shape defined by elongate heater casing walls, preferably, wherein the heater casing walls are in the form of a hollow tube.
   Example Ex9: A heater assembly according to any preceding example in which the heater casing defined an elongate cavity surrounding at least a portion of the heating chamber, the elongate cavity preferably having a substantially polygonal transverse cross-section, for example a transverse cross-section that is a substantially polygonal shape selected from the list consisting of circle, ellipse, decagon, nonagon, octagon, heptagon, hexagon, pentagon, square, rectangle, and triangle.
   Example Ex10: A heater assembly according to any preceding example in which the heater casing is a longitudinally extending heater casing, preferably a substantially tubular heater casing.
   Example Ex11: A heater assembly according to any preceding example in which the heater casing is arranged radially distanced from the heating chamber, for example in which an internal surface of a wall of the heater casing is spaced or radially spaced from an external surface of a wall of the heating chamber.
   Example Ex12: A heater assembly according to any preceding example in which the heater casing comprises or defines an air-tight space.
   Example Ex13: A heater assembly according to example Ex 12 in which the air-tight space is defined between an internal surface of a wall of the heater casing and an external surface of a wall of the heating chamber.
   Example Ex14: A heater assembly according to any preceding example in which the microporous insulating material is arranged in contact with an external surface of the heater casing.
   Example Ex15: A heater assembly according to any of Ex1 to Ex13 in which the microporous insulating material is substantially spaced from an external surface of the heater casing, for example spaced by a distance of greater than 0.01 mm, for example between about 0.1 mm and 5 mm, for example between 0.5 mm and 4.5 mm, for example between 1 mm and 4 mm, for example between 1.5 mm and 3.5 mm, for example between 2 mm and 3 mm, for example about 2.5 mm.
   Example Ex16: A heater assembly according to any preceding example in which the microporous insulating material substantially surrounds the heater casing.
   Example Ex16A: A heater assembly according to any preceding example in which the microporous insulating material radially encircles the heater casing, for example in which the heater casing has a substantially cylindrical outer surface and the microporous insulating material radially encircles or surrounds at least a central portion of the heater casing.
   Example Ex17: A heater assembly according to any preceding example in which the microporous insulating material has a thickness of between 0.1 mm and 5 mm, for example for example between 0.5 mm and 4.5 mm, for example between 1 mm and 4 mm, for example between 1.5 mm and 3.5 mm, for example between 2 mm and 3 mm, for example about 2.5 mm.
   Example Ex18: A heater assembly according to any of the preceding examples, wherein the microporous insulating material has a thermal conductivity of below 0.05 W/m·K, preferably of below 0.04 W/m·K, more preferably of below 0.03 W/m·K, at a temperature of 280 degrees Celsius.
   Example Ex19: A heater assembly according to any of the preceding examples, wherein the thermal conductivity of the microporous insulating material increases by a maximum of 40 percent, preferably by a maximum of 30 percent, more preferably by a maximum of 20 percent at a temperature of 280 degrees Celsius compared to the thermal conductivity of the microporous insulating material at room temperature.
   Example Ex20: A heater assembly according to any of the preceding examples, wherein the microporous insulating material has a pore diameter of below 100 nanometers, preferably of below 70 nanometers, more preferably of below 50 nanometers, more preferably of below 20 nanometers, more preferably of below 2 nanometers.
   Example Ex21: A heater assembly according to any preceding example in which the microporous insulating material is a ceramic material, for example a silica based or alumina-based material, for example in which the microporous insulating material is selected from the list of materials consisting of MICROSIL Microporous Insulation from ZIRCAR Ceramics, Inc., Excelfrax® from Unifrax LLC, and Microtherm 1000 grade from Promat Inc.
   Example Ex22: A heater assembly according to any preceding example, wherein the microporous insulating material is formed from at least a first insulating element comprising at least one first connection element and a second insulating element comprising at least one second connection element, wherein the first and second connection elements are configured as matching connection elements.
   Example Ex23: A heater assembly according to Ex22, wherein the first connection element comprises a male connection element and the second connection element comprises a female connection element.
   Example Ex24: A heater assembly according to Ex22 or Ex23, wherein the first connection element and the second connection element comprise form-fit connection elements.
   Example Ex25: A heater assembly according to any of Ex22 to Ex24, wherein the first connection element and the second connection element comprise snap-fit connection elements.
   Example Ex26: A heater assembly according to any of Ex22 to Ex24, wherein the first connection element and the second connection element comprise bayonet connection elements.
   Example Ex27: A heater assembly according to any preceding example, further comprising a first connecting wall connecting the heating chamber and the heater casing and a second connecting wall connecting the heating chamber and the heater casing wherein a space is defined between the heating chamber, the heater casing, and the first and second connecting walls, for example wherein an air-tight space is defined between the heating chamber, the heater casing, and the first and second connecting walls.
   Example Ex28: A heater assembly according to Ex27, wherein the connecting walls are oriented perpendicular to a longitudinal axis of the heating chamber.
   Example Ex29: A heater assembly according to Ex12 or any example dependent from Ex12, wherein the air-tight space is at ambient pressure, or wherein the air-tight space is at least partly filled with a gaseous composition at ambient pressure.
   Example Ex30: A heater assembly according to any preceding example in which the microporous insulating material is a first portion of microporous insulating material and in which the heater assembly comprises a second portion of microporous insulating material arranged between an internal surface of the heater casing and an external surface of the heating chamber.
   Example Ex31: A heater assembly according to Ex30 in which the heater casing comprises or defines an air-tight space, for example in which the air-tight space is defined between an internal surface of a wall of the heater casing and an external surface of a wall of the heating chamber, wherein the air-tight space contains the second portion of microporous insulating material.
   Example Ex32: A heater assembly according to Ex30 or Ex31 in which the second portion of microporous material is a different microporous material to the first portion of microporous material.
   Example Ex33: A heater assembly according to any of Ex30 to Ex32 in which the second portion of microporous insulating material has a thickness of between 0.1 mm and 5 mm, for example for example between 0.5 mm and 4.5 mm, for example between 1 mm and 4 mm, for example between 1.5 mm and 3.5 mm, for example between 2 mm and 3 mm, for example about 2.5 mm.
   Example Ex34: A heater assembly according to any of Ex30 to Ex33, wherein the second portion of microporous insulating material has a thermal conductivity of below 0.05 W/m·K, preferably of below 0.04 W/m·K, more preferably of below 0.03 W/m·K, at a temperature of 280 degrees Celsius.
   Example Ex35: A heater assembly according to any of Ex30 to Ex33, wherein the thermal conductivity of the second portion of microporous insulating material increases by a maximum of 40 percent, preferably by a maximum of 30 percent, more preferably by a maximum of 20 percent at a temperature of 280 degrees Celsius compared to the thermal conductivity of the microporous insulating material at room temperature.
   Example Ex36: A heater assembly according to any of Ex30 to Ex35, wherein the second portion of microporous insulating material has a pore diameter of below 100 nanometers, preferably of below 70 nanometers, more preferably of below 50 nanometers, more preferably of below 20 nanometers, more preferably of below 2 nanometers.
   Example Ex37: A heater assembly according to any of Ex30 to Ex36, in which the second portion of microporous insulating material is a ceramic material, for example a silica based or alumina-based material, for example in which the second portion of microporous insulating material is selected from the list of materials consisting of MICROSIL Microporous Insulation from ZIRCAR Ceramics, Inc., Excelfrax® from Unifrax LLC, and Microtherm 1000 grade from Promat Inc.
   Example Ex38: A heater assembly according to any of Ex31 to Ex37 in which the air-tight space comprises at least one air gap.
   Example Ex39: A heater assembly according to any of Ex31 to Ex38 in which the second portion of microporous insulating material is sandwiched in radial direction between two air gaps.
   Example Ex40: A heater assembly according to any of Ex31 to Ex39, wherein the second portion of microporous insulating material is in direct contact with the heating chamber, for example in direct contact with an outer surface of the heating chamber.
   Example Ex41: A heater assembly according to any of Ex31 to Ex39, wherein the second portion of microporous insulating material is in contact with a heating element disposed on or around an outer surface of the heating chamber.
   Example Ex42: A heater assembly according to any of Ex31 to Ex41, wherein the second portion of microporous insulating material is in direct contact with the heater casing, for example in direct contact with an inner surface of the heater casing.
   Example Ex43: A heater assembly according to any of Ex31 to Ex40 the second portion of microporous insulating material is formed from at least a first insulating element comprising at least one first connection element and a second insulating element comprising at least one second connection element, wherein the first and second connection elements are configured as matching connection elements.
   Example Ex44: A heater assembly according to Ex43, wherein the first connection element comprises a male connection element and the second connection element comprises a female connection element.
   Example Ex45: A heater assembly according to Ex43 or Ex44, wherein the first connection element and the second connection element comprise form-fit connection elements.
   Example Ex46: A heater assembly according to any of examples Ex43 to Ex45, wherein the first connection element and the second connection element comprise snap-fit connection elements.
   Example Ex47: A heater assembly according to any of examples Ex43 to Ex46, wherein the first connection element and the second connection element comprise bayonet connection elements.
   Example Ex48: A heater assembly according to any preceding example wherein the microporous insulating material and/or the second portion of microporous insulating material, extends parallel to the longitudinal axis of the heating chamber.
   Example Ex49: A heater assembly according to any preceding example, wherein a distance between the heating chamber and the heater casing is between 1.5 millimeters and 7 millimeters, preferably between 2 millimeters and 4 millimeters, preferably about 3.1 millimeters.
   Example Ex50: A heater assembly according to any preceding example, further comprising a heating element.
   Example Ex51: A heater assembly according to Ex50, wherein the heating element is arranged at least partly around the heating chamber.
   Example Ex52: A heater assembly according to Ex50 or Ex51, wherein the microporous insulating material has a longitudinal extension that is the same or larger than the longitudinal extension of the heating element.
   Example Ex53: A heater assembly according to any of Ex50 to Ex52, wherein the heating element is flexible and is wrapped around the heating chamber.
   Example Ex54: A heater assembly according to any of Ex50 to Ex53, wherein the heating element is arranged between the heating chamber and the heater casing.
   Example Ex55: A heater assembly according to any of Ex50 to Ex54, wherein the heating element comprises one or more electrically conductive tracks on an electrically insulating substrate.
   Example Ex56: A heater assembly according to any preceding example, wherein the ratio of an external diameter of the heater casing to an external diameter of the heating chamber is between 1.3 to 3.5, preferably between 1.5 and 2.5, more preferably about 2.0.
   Example Ex57: A heater assembly according to any preceding example, wherein an inner side of a wall of the heater casing comprises a metal coating.
   Example Ex58: A heater assembly according to any preceding example, wherein a wall of the heating chamber comprises stainless steel.
   Example Ex59: A heater assembly according to any preceding example, wherein the thickness of one or more heater casing wall is below 2 millimeters, preferably below 1.2, preferably about 0.8 millimeter.
   Example Ex60: A heater assembly according to any preceding example, wherein one or more heater casing wall comprises a plastic material, preferably a polyaryletherketone (PAEK), a polyether ether ketone (PEEK), or a polyphenylene sulfone (PPSU), more preferably a polyphenylene sulfone (PPSU).
   Example Ex61: An aerosol-generating device comprising the heater assembly according to any preceding example.
   Example Ex62: An aerosol-generating device according to Ex61 comprising a housing, a power supply, control electronics, and the heater assembly according to any of examples Ex1 to Ex61.
   Example Ex63: An aerosol-generating device according to Ex61 or Ex62 in which the heater assembly is located by or within a housing of the aerosol-generating device, in which the microporous insulating material is located between an outer surface of the heater casing and an inner surface of the housing.
   Example Ex64: An aerosol-generating device according to Ex63 in which the microporous insulating material is spaced from the inner surface of the housing.
   Example Ex65: An aerosol-generating device according to Ex63 or Ex64 in which the microporous insulating material is paced from both the inner surface of the housing and from the outer surface of the heater casing.
   Example Ex66: An aerosol-generating device according to Ex63 in which the microporous insulating material substantially fills a space defined between the outer surface of the heater casing and the inner surface of the housing.
   Example Ex67: An aerosol-generating device according to any of Ex61 to Ex66 in which the heating chamber is defined by substantially cylindrical heating chamber walls, in which the heater casing is defined by substantially cylindrical heater casing walls located radially external to the heating chamber, in which the microporous insulating material is located radially external to the heater casing walls, and in which the housing is located radially external to the microporous insulating material.
   Example Ex68: An aerosol-generating device according to Ex67 in which a heater is located on at least a portion of an external surface of the heating chamber walls.
   Example Ex69: An aerosol-generating device according to Ex67 or Ex68 in which a sealed air-gap is defined between the heating chamber and the heater casing.
   Example Ex70: An aerosol-generating device according to any of examples Ex67 to Ex69 in which the aerosol-generating device comprises a heater and in which control electronics located within the housing control operation of the heater.
   Example Ex71: An aerosol-generating device according to any of Ex61 to Ex70 in which an airflow path is defined through the heating chamber.
   Example Ex72: An aerosol-generating device according to Ex71 in which the airflow path does not contact the microporous insulating material.
   Example Ex73: An aerosol-generating system comprising an aerosol-generating device according to any of examples Ex61 to Ex72 and an aerosol-forming substrate configured to be at least partly received in the heating chamber.
   Example Ex74: An aerosol-generating system according to Ex73 in which the aerosol-forming substrate is a component of an elongate aerosol-generating article, the aerosol generating article comprising the aerosol-forming substrate, and a mouthpiece located upstream of the aerosol-forming substrate.
   Example Ex75: An aerosol-generating system according to example Ex74 in which the aerosol-generating article is a substantially cylindrical aerosol-generating article having a diameter of between 4 mm and 8 mm, for example between 4.5 mm and 7.5 mm, for example between 5 mm and 7.2 mm, and in which the aerosol-generating device comprises an opening configured to allow a portion of the aerosol-generating device to be inserted into the heating chamber.
   Example Ex76: An aerosol-generating system according to Ex75 in which the heating chamber has an internal diameter that is approximately the same as the diameter of the aerosol-generating article.
Features described in relation to one embodiment may equally be applied to other embodiments of the invention.

The invention will be further described, by way of example only, with reference to the accompanying drawings in which:

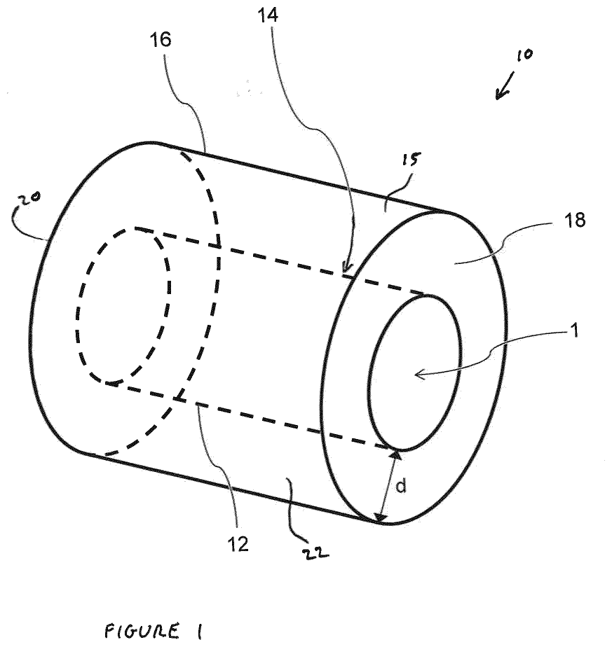

FIG. 1 is a schematic illustration of an embodiment of a heater assembly for an aerosol-generating device;

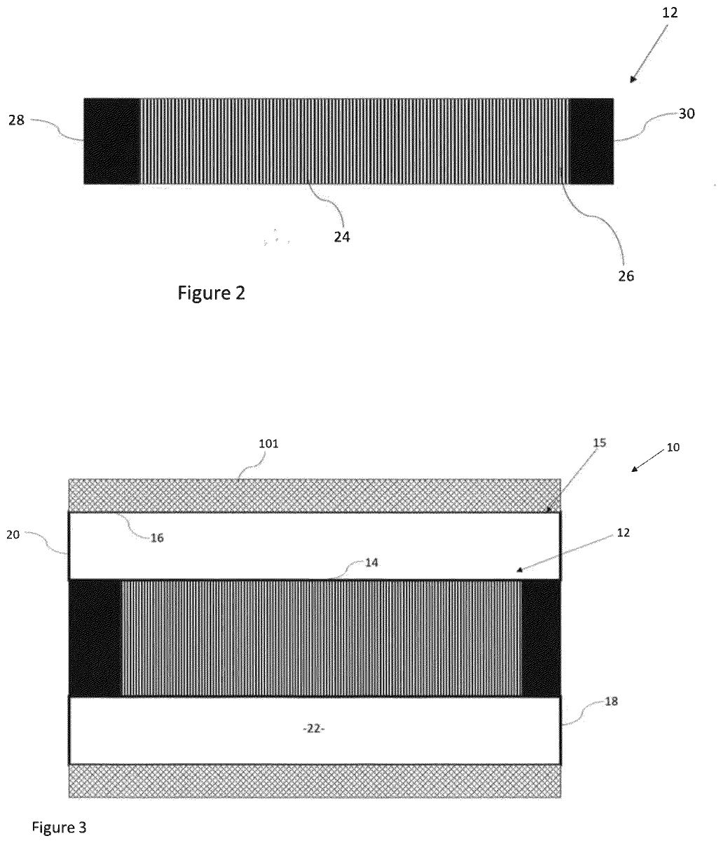

FIG. 2 shows an embodiment of a heating chamber for a heater assembly, for example for the heater assembly of FIG. 1;

FIG. 3 shows a schematic cross-sectional view of the heater assembly of FIG. 1;

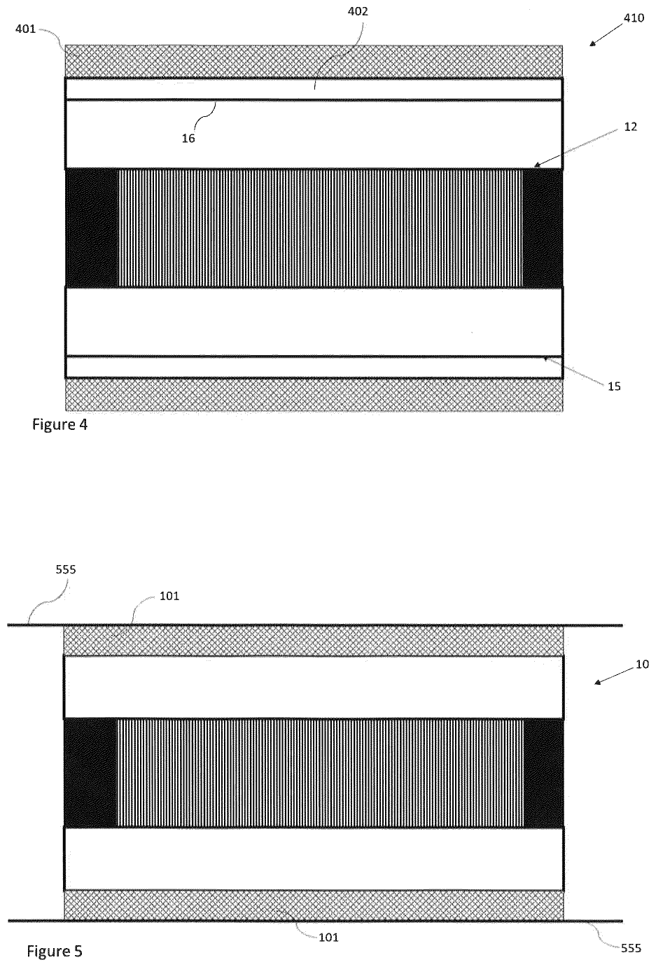

FIG. 4 shows a schematic cross-sectional view of a second embodiment of a heater assembly for an aerosol-generating device;

FIG. 5 shows the heating assembly of FIG. 3 when mounted within a housing of an aerosol-generating device;

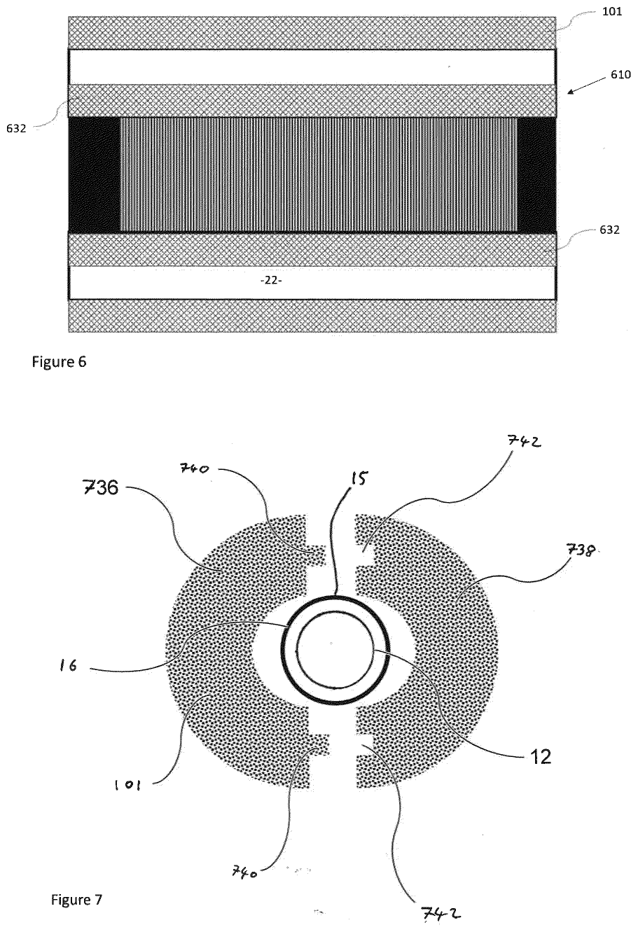

FIG. 6 shows a schematic cross-sectional view of a third embodiment of a heater assembly for an aerosol-generating device;

FIG. 7 is a schematic illustration showing the modular construction of an embodiment of microporous insulating material for a heater assembly; and

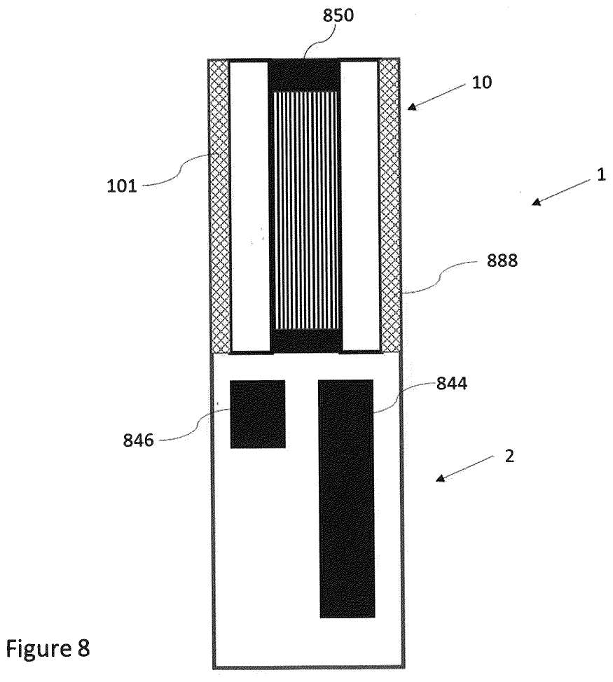

FIG. 8 shows an embodiment of an aerosol-generating device comprising the heater assembly as illustrated in FIG. 3.

FIG. 1 schematically shows an embodiment of a heater assembly 10. The heater assembly 10 comprises a heating chamber 12 for heating an aerosol-forming substrate. The heating chamber 12 has an elongate shape. The heating chamber 12 comprises a heating chamber wall 14 circumscribing a cavity 1 for insertion of the aerosol-forming substrate. The wall of the heating chamber 14 forms a hollow tube. The heater assembly 10 further comprises a heater casing 15. The heater casing 15 is arranged coaxially around the heating chamber 12. The heater casing 15 comprises a cylindrical heater casing wall 16. The heater casing 15 is further arranged radially distanced from the heating chamber 12 at a distance d. The distance d is measured in a radial direction between an outer diameter of the hollow tube formed by the wall of the heating chamber 14 and an inner diameter of the cylindrical wall of the heater casing 16. The wall of the heating chamber 14 and the wall of the heater casing 16 have matching shapes. Thereby, the distance d is constant along the longitudinal axis of the heating chamber 12. A microporous insulating material is arranged externally to the heater casing.

The heater assembly 10 further comprises a first connecting wall 18 at a proximal end of the heater assembly 10. The heater assembly 10 further comprises a second connecting wall 20 at a distal end of the heater assembly 10. The first and second connecting walls 18, 20 are oriented perpendicular to a longitudinal axis of the heating chamber 12. In the specific embodiment of FIG. 1, the heater assembly 10 further comprises an air-tight space 22. The air-tight space 22 is defined between the wall of the heating chamber 14, the wall of the heater casing 16, and the first and second connecting walls 18, 20.

FIG. 2 shows an embodiment of a heating chamber 12 for a heater assembly. The heating chamber 12 comprises a central region comprising a heating element. The heating element is arranged partly around the heating chamber 12. The wall of the heating chamber 14 is a metal tube. The heating element is flexible and is wrapped around the metal tube. The heating element comprises electrically conductive heating tracks 24 on an electrically insulating flexible substrate 26. A proximal region 28 and a distal region 30 of the heating chamber 12 are distanced from the heating element in a longitudinal direction.

FIG. 3 shows an embodiment of a heater assembly 10 comprising the heating chamber 12 of FIG. 2. The heating element is arranged between the heating chamber 12 and the heater casing 15.

The first and second connecting walls 18, 20 sealingly connect the heater casing wall 16 with the heating chamber wall 14, thereby air-tightly enclosing the air-tight space 22. The first and second connecting walls 18, 20 contact the heating chamber 12 at positions distanced from the heating element. The first and second connecting walls 18, 20 thus contact the heating chamber 12 at the coldest points of the heating chamber when being heated during use. Thereby, heat losses due to heat transport from the heating chamber 12 to the connecting walls 18, 20 and the heater casing 15 via thermal conduction are reduced. Thermal insulation of the heater assembly is additionally improved, however, by a layer of microporous insulating material 101 arranged coaxially around the heater casing 15. The microporous insulating material is in contact with an outer surface of the heater casing wall 16 and is arranged coaxially around the heater casing. The microporous insulating material 101 may be for example one of MICROSIL Microporous Insulation from ZIRCAR Ceramics, Inc.; Excelfrax® from Unifrax I LLC and Microtherm 1000 grade from Promat Inc or other commercially available microporous insulating materials.

In the embodiment shown in FIG. 3 the whole air-tight space 22 is empty. In other embodiments, however, the air-tight space may contain a second microporous insulating material. In still further embodiments, the gap between the heating chamber and the heater casing need not be an airtight space. In still further embodiments, the heating element may be arranged within the cavity defined by the heating chamber.

Although not shown, the microporous insulating material 101 shown in FIG. 3 may also comprise one or more air gaps extending in a direction parallel to the longitudinal axis of the heating assembly. Those air gaps may be in direct contact with the wall of the heater casing 16. Those air gaps may have a shorter longitudinal extension then the microporous insulating material 32.

FIG. 4 illustrates an alternative specific embodiment of a heater assembly 410. The heater assembly 410 is substantially the same as the heater assembly 10 illustrated in FIG. 3, with the difference that a layer of microporous insulating material 401 arranged externally to the heater casing 15 is spaced from the heater casing wall 16 by a gap 402. The gap 402 may be an airtight gap.

FIG. 5 illustrates a heater assembly 10 as illustrated in FIG. 3, in which the heater assembly is mounted as a component of an aerosol-generating device. In the illustration of FIG. 5, an outer surface of the microporous insulating material is arranged in contact with at least a portion of the aerosol-generating device housing 555. A user may, for example, pick up the aerosol-generating device and contact the housing. Thermal transfer between the heater casing and an outer surface of the housing 555 is reduced by the presence of the microporous insulating material 101.

FIG. 6 illustrates an alternative specific embodiment of a heater assembly 610. The heater assembly 610 is substantially the same as the heater assembly 10 illustrated in FIG. 3, with the difference that a second layer of microporous insulating material 632 is present. This second layer of microporous insulating material 632 is located within the air gap 22, in direct contact with the heating chamber 12 and the heating element that surrounds the heating chamber.

The microporous insulating material 101, 401 may be configured as a two-part assembly. FIG. 7 shows a two-part assembly of the microporous insulating material 101. Any of the heater assemblies 10, 410, 610 depicted in FIGS. 3, 4, 5 and 6 may comprise the two-part assembly of FIG. 7. As can be seen in FIG. 7, the microporous insulating material 101 is formed from a first insulating element 736, having a first connection element 740 and a second insulating element 738, having a second connection element 742. The first and second connection elements 740 and 742 are configured as matching connection elements. When the two first and second insulating elements 736 and 738 are connected, the first and second connection elements 740 and 742 connect with each other. The connection of the first and second connection elements 740 and 742 provides a direct contact of the first and second insulating elements 736 and 738. The first and second insulating elements 736 and 738 can have a hollow half-cylinder design as shown in FIG. 7. However, other shapes and configurations are possible. When connected, the hollow half-cylinder design provides a hollow tube. The hollow tube may have the same inner diameter as the external diameter of the heater casing wall 16. By this two-part assembly, the microporous insulating material 101 can have a perfect fit with the heater casing 15.

FIG. 8 shows an embodiment of an aerosol-generating device 1 comprising the heater assembly 10 of FIG. 3. The aerosol-generating device further comprises a power supply 2. The power supply 2 comprises a power source 844 and control electronics 846. The power source 844 may be a rechargeable battery. In the embodiment of FIG. 8, an outer housing 888 of the aerosol-generating device 1 locates the power supply 2 and the heater assembly 10. An outer surface of the microporous insulation material 101 of the heater assembly 10 is in contact with an inner surface of the outer housing 888. An aerosol-forming substrate may be inserted at least partly into the heating chamber of the heater assembly 10 through opening 850. The aerosol-forming substrate may be part of an aerosol-generating article.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A heater assembly for an aerosol-generating device, the heater assembly comprising:
a heating chamber configured to heat an aerosol-forming substrate, the heating chamber being defined by heating chamber walls; and
a heater casing arranged externally to the heating chamber, the heater casing being defined by heater casing walls; and
a microporous insulating material arranged externally to the heater casing,
wherein the microporous insulating material is formed from at least a first insulating element comprising at least one first connection element and a second insulating element comprising at least one second connection element, and
wherein the first connection element and the second connection element are configured as matching connection elements.

17. The heater assembly according to claim 16, wherein the heater casing is arranged around the heating chamber.

18. The heater assembly according to claim 16, wherein the heater casing substantially surrounds the heating chamber.

19. The heater assembly according to claim 16, wherein the microporous insulating material is arranged in contact with an external surface of the heater casing.

20. The heater assembly according to claim 16, wherein the microporous insulating material is substantially spaced from an external surface of the heater casing.

21. The heater assembly according to claim 16, wherein the microporous insulating material is spaced from an external surface of the heater casing by a distance of between about 0.1 mm and 5 mm.

22. The heater assembly according to claim 16, wherein the microporous insulating material substantially surrounds the heater casing.

23. The heater assembly according to claim 16, wherein the microporous insulating material radially encircles the heater casing.

24. The heater assembly according to claim 23, wherein the heater casing has a substantially cylindrical outer surface and the microporous insulating material radially encircles or surrounds at least a central portion of the heater casing.

25. The heater assembly according to claim 16, wherein the microporous insulating material has a thickness of between 0.1 mm and 5 mm.

26. The heater assembly according to claim 16, wherein the microporous insulating material has a thickness of about 2.5 mm.

27. The heater assembly according to claim 16, wherein the microporous insulating material has a thermal conductivity of below 0.05 W/m·K at a temperature of 280 degrees Celsius.

28. The heater assembly according to claim 16, wherein the microporous insulating material has a thermal conductivity of below 0.03 W/m·K at a temperature of 280 degrees Celsius.

29. The heater assembly according to claim 27, wherein the first connection element comprises a male connection element and the second connection element comprises a female connection element.

30. The heater assembly according to claim 27, wherein the first connection element and the second connection element comprise form-fit connection elements.

31. The heater assembly according to claim 27, wherein the first connection element and the second connection element comprise snap-fit connection elements.

32. The heater assembly according to claim 27, wherein the first connection element and the second connection element comprise bayonet connection elements.

33. The heater assembly according to claim 16,
wherein the microporous insulating material is a first portion of microporous insulating material, and
wherein the heater assembly further comprises a second portion of microporous insulating material arranged between an internal surface of the heater casing and an external surface of the heating chamber.

34. The heater assembly according to claim 33,
wherein the heater casing comprises or defines an air-tight space, and
wherein the air-tight space contains the second portion of microporous insulating material.

35. The heater assembly according to claim 34, wherein the air-tight space is defined between an internal surface of a wall of the heater casing and an external surface of a wall of the heating chamber.
